(19) United States
(12) Patent Application Publication
(10) Pub. No.: US 2010/0132580 A1
(43) Pub. Date: Jun. 3, 2010

(54) Net throwing device

(76) Inventor: Andrey Evgenievich Nazdratenko, Vladivostok (RU)

Correspondence Address: DEFILLO & ASSOCIATES, INC., P.O. Box 14104, Clearwater, FL, 33766, US

(21) Appl. No.: 11/918,539

(22) PCT Filed: Mar. 6, 2007
(86) PCT No.: PCT/RU2007/000107

§ 371 Date: Oct. 15, 2007

(30) Foreign Application Priority Data
Jul. 17, 2006 (RU) 2006125971

(51) Int. Cl. F42B 12/56; F41B 15/00; F41H 13/00; A01M 99/00

(52) U.S. Cl. 102/502; 124/56; 43/1

(57) ABSTRACT

The net throwing device contains sleeve (1) with stop end, net ejecting means (2) from sleeve channel (1), folded net (3) and means for opening the net after its ejection from sleeve channel (1), including may weights (7) for opening net (3) attached to it around the periphery. Means for opening the net also contains closing plug (4) placed in sleeve channel (1) between net ejecting means (2) and folded net (3). Weights (7) are installed in many sockets of closing plug (4) made according to the number of weights (7). Closing plug (4) contains means for simultaneous ejection of all weights (7) from closing plug sockets (4) in radial directions outside the sleeve channel (1).

### CROSS REFERENCE TO RELATED APPLICATION

This application is a national stage of PCT/RU2007/000107 filed Mar. 6, 2007 and based upon Russian Application No. 2006125971 filed Jul. 17, 2006, under the International Convention.

### TECHNICAL FIELD

The present invention relates to non-flying weapon, in particular, to devices for trapping biological objects by throwing a net and may be used in maintenance of public order, as well as for trapping domestic and wild animals and birds.

### BACKGROUND ART

We are aware of a net throwing device that contains a housing in the interior of which there is a gas-expansion power source, folded net and a means for its folding, including the weights attached around the periphery of a net (application JP 2002-355323, published on Dec. 10, 2002). As a result of gas expansion the net is ejected from the housing outlet, opened under the effect of the weights flying apart and covers a nearby biological object to be trapped. The basic disadvantages of such device are a small effective range, unsuitability to use for a long distance, inadequately developed system of opening the net.

There is a device for net throwing that contains a housing made as a head-detachable projectile, in the interior of which there is a gas-expansion power source as powder charge, folded net and a means for its opening, including the wrights fastened around the periphery of a net (patent FR 859282, published on Dec. 14, 1940). When flying up to a biological object to be trapped under the effect of an ignited powder charge the projectile head is detached releasing a way of the net, which leaves the casing and is opened in flight by weights flying apart, then it covers the objects and gets caught in it. The basic disadvantages of this device are a bounded area of its use, unsuitability to use for a short distance, complexity of construction as well as unreliability of a net-opening means.

As a prototype we have chosen a net throwing device that contains a housing, in the interior of which there is a gas-expansion power source, folded net treated with adhesive substance and a means for its opening as weights fastened around the periphery of the net (application CA 2162221, published on May 8, 1996). The basic disadvantages of the known device are a bounded area of its use and unreliability of a net-opening means.

### DISCLOSURE OF THE INVENTION

The technical problem in hand is to improve a means, enhance reliability of the net-opening means of the net throwing device in order to increase its reliability as well as to provide a way of applying the net throwing device for various distances.

The net throwing device according to the present invention contains a sleeve with stop end held by hand when shooting, means for ejecting the net from the sleeve channel when shooting placed in the sleeve as viewed from the stop end of the sleeve, folded net and means for its opening after its ejection from the sleeve channel that includes many weights for opening the net attached to the net around its periphery. A new thing is that the means for opening the net additionally contains a closing plug placed in the sleeve channel between the net ejecting means and folded net, as this takes place, the weights are installed in many sockets of the closing plug built in the closing plug according to the number of weights, and the closing plug contains a means for simultaneous ejection of all weights from the closing plug sockets in radial directions outside the sleeve channel.

It is desirable that the net ejecting means to be made as a gas expansion power source.

It would be better to make the closing plug sockets as radial, in so doing, the closing plug sockets have outlets on a lateral generating line of the closing plug, and inlets of the closing plug sockets are in communication with a space inside the sleeve channel between the closing plug and net ejecting means. Such hole-socket system in the closing plug serves as a means for simultaneous ejection of all weights due to gas expansion power.

It is desirable to make the closing plug as a cup piston placed in the sleeve channel so that the cup faces the net ejecting means, and the closing plug sockets are built in the piston bottom. At that, in the closing plug coaxially there may be made a blind hole opening towards the net ejecting means, and outlets of the closing plug sockets are in communication with this blind hole.

In accordance with other version, the closing plug sockets are made as radial, weights are installed in the closing plug sockets by a slide fit, at that, the closing plug sockets have outlets on a lateral generating line of the closing plug, and the means for ejecting the weights contains many springs mounted in the closing plug sockets and padding the weights towards the outlets of the closing plug sockets. Such construction of the closing plug serves as a means for simultaneous ejection of all weights due to potential energy of compressed springs.

At that, the weights may be padded so that to seat against the interior walls of the sleeve channel.

Also, the weights may be padded so that to seat against a ring mounted on the closing plug along its lateral generating line and inserted in the sleeve channel together with the closing plug, in this case, the ring is made in such a way so to release the lateral generating line of the closing plug outside the sleeve open end.

In addition, the means for ejecting the weights may additionally contain a starting element that protrudes beyond the folded net and is connected with the ring so that the starting element enables the ring to release the lateral generating line of the closing plug when a protruding part of the starting element strikes against an obstacle. In addition, a protruding part of the starting element may be provided with a fairing.

Additionally, the ring may be made as lateral cup wall, interior surface of the cup bottom comes in contact with an end part of the closing plug faced the net ejecting means, the closing plug has a central through hole, and the starting element is made as a central pin arranged along the longitudinal axle of the sleeve channel that passes with a slide fit through a central through hole and is attached by one end to the cup bottom, and its other loose end passes through the folded net protruding outside its limits.

Also, the ring may be incorporated in a lateral wall of the cup-like case that is mounted on the closing plug by a peripheral part of the lateral wall along its lateral generating line and is inserted together with the closing plug into the sleeve channel in such a way so the folded net is arranged inside the cup-like case, in so doing, the cup-like case is made with a possibility of breaking with the help of the starting element outside the sleeve open end in order to release weights and folded net when a protruding part of the starting element strikes against an obstacle. At that, the closing plug may have a central through hole, and the starting element is made as a central pin arranged along the longitudinal axle of the sleeve channel, one end of which comes with a slide fit into the central through hole and its other loose end passes through the folded net protruding outside its limits and limits of the cup-like case in such a way so to have a way to break the case by loose end when it strikes against an obstacle.

It would be better when the central pin passes through a central cell of the folded net.

The closing plug sockets should have round cross section. At that, weights may have cylindrical or spherical form.

It would be better to make the weights of the same mass and form and to install them in the closing plug equally with the same diameter.

The sleeve should be made as cylindrical with a cylindrical channel.

Weights may be attached to the periphery of the net with the help of straps.

The sleeve open end may be closed with an easy-removable cover or easy-destructible case.

### BRIEF DESCRIPTION OF THE DRAWING

The present invention is explained in detail with references to the following drawing figures:

FIG. 1—shows a general view in longitudinal section of the device in accordance with one embodiment of the present invention for net throwing for short distance;

FIG. 2—shows a view in cross section A-A of the device with FIG. 1;

FIG. 3—shows a view in longitudinal section showing a version of making the closing plug as a cup piston of the device with FIG. 1;

FIG. 4—shows a general view in longitudinal section of the first version of the device in accordance with other embodiment of the present invention for net throwing for long distance;

FIG. 5—shows a view in cross section B-B of the device with FIG. 4;

FIG. 6—shows a general view in longitudinal section of the second version of the device in accordance with other embodiment of the present invention for net throwing for long distance; and

FIG. 7—shows a view in cross section C-C of the device with FIG. 6

### THE BEST EXAMPLE FOR CARRYING OUT THE INVENTION

The invention is explained in detail by the examples of specific embodiment.

### Example 1

### Device Equipped for Net Throwing for Short Distance

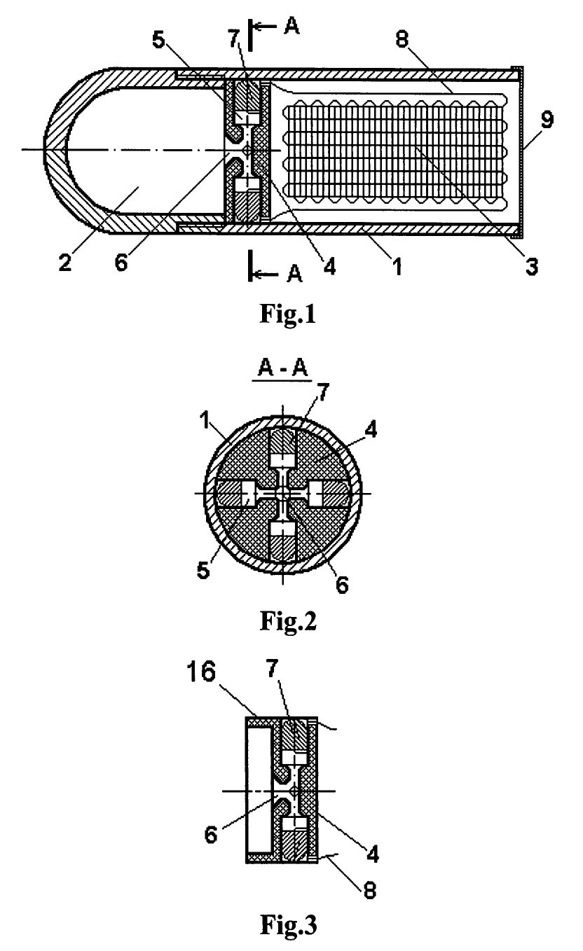

The net throwing device (see FIG. 1 and FIG. 2) contains an aluminum sleeve 1 of cylindrical form with the channel diameter 35 mm. On the rear end of sleeve 1 with the help of thread there is installed detachable seal 2. In sleeve 1 as viewed from seal 2 there is inserted a compressed-gas bottle (not shown), which is detached from net 3 being folded, closing plug 4 made as monolithic from molded fluoroplastic. Diameter of closing plug 4 is equal to the diameter of sleeve channel 1 and is 45 mm, thickness of closing plug 4 is 11 mm. On the edges of closing plug 4 there are four sockets 5, radially arranged in the mid-part of its thickness which have a round cross section and are intended for installation of weights 7 in them. Diameter of socket 5 is equal to 6 mm, and depth of socket 5 is equal to 17 mm. Weights 7 are made of lead, have cylindrical form with a rounded front part in the form of a gun bullet and are attached to the periphery of folded net 3 with the aid of straps 8. Sockets 5 are connected with passage channels of the same length and cross section with central blind hole 6 opened towards detachable seal 2 with a bottle.

When equipping the device, weights 7 are installed in sockets 5 of closing plug 4, after that, closing plug 4 together with weights 7 is inserted through the open end of sleeve 1 in its channel up to the stop against the protruding ends of seal 2, then, folded net 3 is placed on closing plug 4, after that the open end of sleeve 1 as viewed from folded net 4 is covered with flat cover 9, which is easy-detachable. Then, detachable seal 2 is unscrewed and a compressed-gas bottle (not shown) is installed through the rear part of sleeve 1, and seal 2 is screwed into position.

When the gas bottle is put into operation, gasses are expanded and deliver pressure to the back surface of closing plug 4, which under their action begins to move towards the open part of sleeve 1 pushing folded net 3, in so doing, cover 9 is thrown away. As the same time, the expanded gases penetrate into central hole 6 into sockets 5, where weights 7 are installed 7 and bring pressure to the back part of weights 7. Directly when leaving the open end of sleeve 1, weights 7 stop to bear up against sleeve channel 1, as a result of this, under the effect of expanded gas they leave sockets 5 in radial direction and entrain straps 8, which spread net 3 during its flying. At that, net 3 continues to move towards a trapped biological object closed located, and covers it, wraps around it and prevents it from movement.

In FIG. 1 and FIG. 2 the device contains closing plug 4 made as a disc. With the purpose of increasing reliability of escaping weights 7 from sockets 5, closing plug 4 may be made as a cup cylinder 16 as shown in FIG. 3. owing to such construction the time of effect of expanded gas on the back part of weights 7 when closing plug 4 escapes sleeve channel 1 is increased by the time of passing cup 16 of the open end of sleeve 1 along its length.

Any suitable igniter may be used instead of a gas bottle, in particular, that enables to throw net 3 at the expense of burning gasses.

### Example 2

### Device Equipped for Net Throwing for Long Distance, First Version

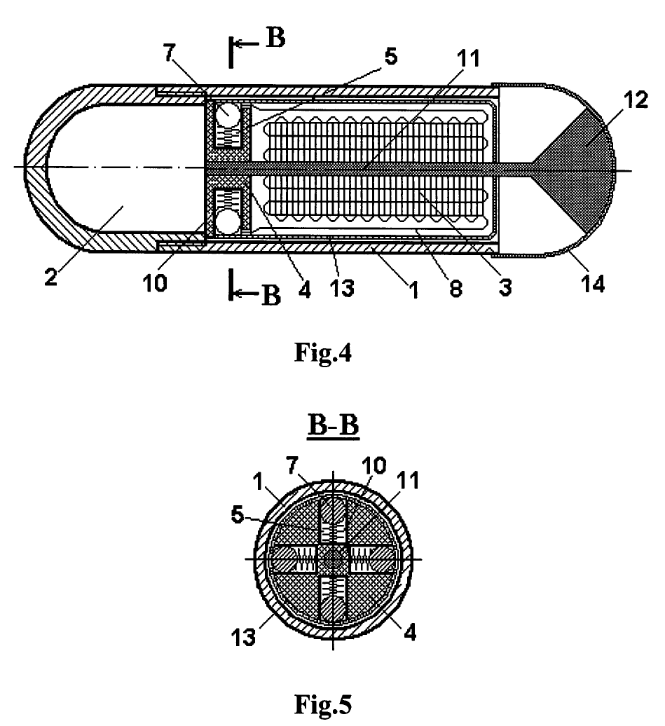

The construction of the device (see FIG. 4 and FIG. 5) is similar to example 1, except that weights 7 installed in sockets are padded with helical springs 10, and in the center of closing plug 4 there is a through hole, in which central pin is installed to slide, the pin passes through the central cell of folded net 3 at an equal distance from its edges. In order to open net 3 more efficiently when flying to a trapped object and striking against its body, on the loose end of central pin 11 there is cone-shaped fairing 12. In order to exclude an accidental injury of a biological object by weights flying apart 7, expansion angle of fairing 12 in respect to the axle of pin 11 may be about 45°. Folded net 3 has thin case 13 made of fragile plastic, one edge of which covers closing plug 4 with an allowance in order to overlap padded weights 7. Central pin 11 protrudes from the open part of sleeve 1 by 20-40 mm, which provides on impact the destruction of thin case 13 by cone-shaped fairing 12, release of edges of closing plug 4 and free freight of weights 7 from sockets 5 under the effect of unclasping springs 10. The open end of sleeve 1 and expansion protruding from it 12 of guide pin 11 with closed with easy-removable cover 14 made as hemisphere.

After flying from sleeve channel 1 the system including closing plug together with padded weights 7, folded net 3, case 13 and central pin 13 flies to the object like an arrow, and the net is opened at the expense of radial flying of weights 7 only after strike of fairing 12 against this object.

### Example 3

### Device Equipped for Net Throwing for Long Distance, Second Version

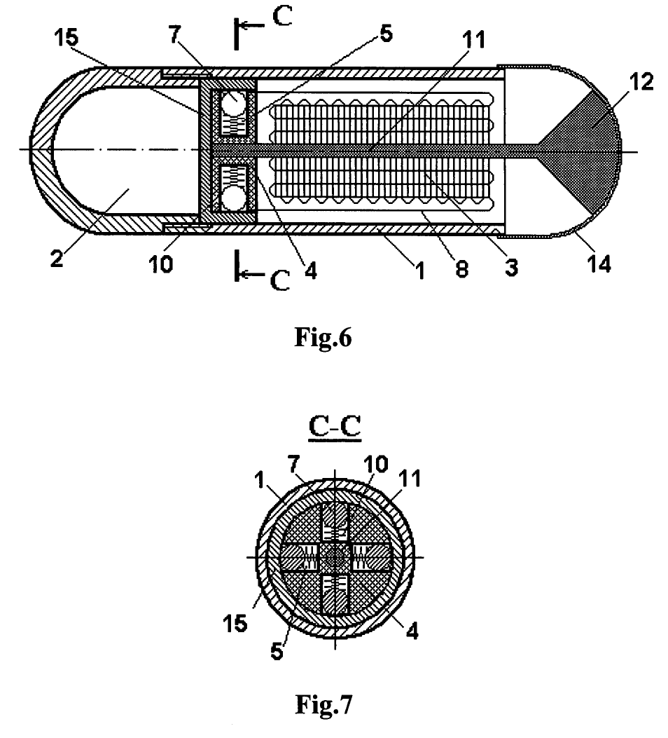

The construction of the device (see FIG. 6 and FIG. 7) is similar to example 2, except that sliding metal ring 15 is put on closing plug 4 in the form of a cup so that it overlaps sockets 5 with padded weights 7 installed in them. Weights 7 are padded in closing plug 4 so that they are seated against ring 15 put on closing plug 4 with a slide fit along its lateral generating line, at that, ring 15 is made in such a way so to enable to slip off closing plug 4 outside the open end of sleeve 1. Means for pushing weights 7 includes a starting element as central pin 11 protruding folded net 3 and which enables ring 15 to slip off closing plug 4 when striking the protruding part of central pin 11 against an obstacle that as a result of which removes ring 15 from closing plug 4 in reverse direction.

The above example are used only to illustrate the ways of embodiment of the invention and are in no way intended for limitation of legal protection in accordance with the presented claim, at that, a specialist in this area of engineering is rather simply able to implement other versions of embodiment of this invention.

1. A net throwing device comprising:
a stop-end sleeve,
means for ejecting the net from a sleeve channel placed in the sleeve as viewed from a spot end of the sleeve,
a folded net and
means for opening the net after its ejection from the sleeve channel that includes many weights for opening the net attached to the net around its periphery,
differing in that the means for opening the net additionally contains a closing plug placed in the sleeve channel between the net ejecting means and folded net,
wherein the weights are installed in many sockets of the closing plug made according to the number of weights, and
wherein the closing plug contains a means for simultaneous ejection of all weights from the closing plug sockets in radial directions outside the sleeve channel.

2. The net throwing device of claim 1, wherein the net ejecting means is made as gas expansion power source.

3. The net throwing device of claim 2, wherein the closing plug sockets are made as radial, in so doing, the closing plug sockets have outlets on the rear generating line of the closing plug, and inlets of the closing plug sockets are in communication with a space inside the sleeve channel between the closing plug and net ejecting means.

4. The net throwing device of claim 3, wherein the closing plug is made as a cup piston placed in the sleeve channel so that the cup faces the net ejecting means, and the closing plug sockets are built in the piston bottom.

5. The net throwing device of claim 3, wherein in the closing plug coaxially there is a blind hole opening towards the net ejecting means, and outlets of the closing plug sockets are in communication with this blind hole.

6. The net throwing device of claim 1, wherein the closing plug sockets are made as radial, weights are installed in the closing plug sockets by a slide fit, at that, the closing plug sockets have outlets on a lateral generating line of the closing plug, and the means for ejecting the weights contains many springs mounted in the closing plug sockets and padding the weights towards the outlets of the closing plug sockets.

7. The net throwing device of claim 6, wherein the weights are padded so that they are seated against the interior walls of the sleeve channel.

8. The net throwing device of claim 6, wherein the weights are padded so that they are seated against a ring mounted on the closing plug along its lateral generating line and inserted in the sleeve channel together with the closing plug, in this case, the ring is made in such a way so to release the lateral generating line of the closing plug outside the sleeve open end.

9. The net throwing device claim 8, wherein the means for ejecting the weights is additionally contain a starting element that protrudes beyond the folded net and is connected with the ring so that the starting element enables the ring to release the lateral generating line of the closing plug when a protruding part of the starting element strikes against an obstacle.

10. The net throwing device of claim 9, wherein a protruding part of the starting element is provided with a fairing.

11. The net throwing device of claim 9, wherein the ring is made as lateral cup wall, interior surface of the cup bottom comes in contact with an end part of the closing plug faced the net ejecting means, the closing plug has a central through hole, and the starting element is made as a central pin arranged along the longitudinal axle of the sleeve channel that passes with a slide fit through a central through hole and is attached by one end to the cup bottom, and its other loose end passes through the folded net protruding outside its limits.

12. The net throwing device of claim 9, wherein the ring is incorporated in a lateral wall of the cup-like case that is mounted on the closing plug by a peripheral part of the lateral wall along its lateral generating line and is inserted together with the closing plug into the sleeve channel in such a way so the folded net is arranged inside the cup-like case, in so doing, the cup-like case is made with a possibility of breaking with the help of the starting element outside the sleeve open end in order to release weights and folded net when a protruding part of the starting element strikes against an obstacle.

13. The net throwing device of claim 12, wherein the closing plug has a central through hole, and the starting element is made as a central pin arranged along the longitudinal axle of the sleeve channel, one end of which comes with a slide fit into the central through hole and its other loose end passes through the folded net protruding outside its limits and limits of the cup-like case in such a way so to have a way to break the case by loose end when it strikes against an obstacle.

14. The net throwing device of claim 11, wherein the central pin passes through a central cell of the folded net.

15. The net throwing device of claim 1, wherein closing plug sockets have round cross section.

16. The net throwing device of claim 15, wherein weights have cylindrical or spherical form.

17. The net throwing device of claim 1, wherein the wrights are of the same mass and form and are installed in the closing plug sockets equally with the same diameter.

18. The net throwing device of claim 1, wherein the sleeve is made as cylindrical with a cylindrical channel.

19. The net throwing device of claim 1, wherein the weights are attached to the periphery of the net with the help of straps.

20. The net throwing device of claim 1, wherein the sleeve open end is closed with an easy-removable cover or easy-destructible case.
